(19) United States
(12) Patent Application Publication
(10) Pub. No.: US 2006/0256411 A1
(43) Pub. Date: Nov. 16, 2006

(54) Method of preparing an optical security component having a metallic appearance, and component thus produced

(76) Inventors: Florent Denjean, Grisy-Suisnes (FR); Francoise Daniel, Noisiel (FR)

Correspondence Address: YOUNG & THOMPSON, 745 SOUTH 23RD STREET, 2ND FLOOR, ARLINGTON, VA, 22202, US

(21) Appl. No.: 10/548,429

(22) PCT Filed: Mar. 12, 2004
(86) PCT No.: PCT/FR04/00623

§ 371 Date: Jun. 5, 2006

(30) Foreign Application Priority Data
Mar. 12, 2003 (FR) 03/03060

(51) Int. Cl. G03H 1/02

(52) U.S. Cl. 359/4

(57) ABSTRACT

A method of preparing an optical security component having a metallic appearance and having a diffraction grating. The method includes the following steps: preparing a transparent polyester film; depositing a stamping layer, into which the hologram producer has pressed the appropriate microstructures; stamping; vacuum depositing a fine layer of a dielectric material having a high optical index; coating or printing at least one layer of translucent coloured varnish; and vacuum depositing a layer of aluminium. An optical security component thus produced is also disclosed.

The present invention relates to the field of security products with a recognizable optical appearance, and in particular holographic films having a metallized appearance, adapted for marking products and documents.

By holographic film, is meant in the sense of the present application, all the films having a diffraction structure such as those conventionally used for security, identification or authentication of a product or a document. In the present invention, it is of little importance whether these microstructures be registered holographically, or engraved in one manner or another (e-beam for example).

There are known in the prior art two technical solutions permitting producing such holographic films having a metallized appearance.

The first solution consists in carrying out a step of evaporation of specific metals during the operation of production of the film.

This process consists in preparing an optical complex of which FIG. 1 shows a view in cross-section, this optical complex comprising:
a layer 1 formed by a transparent film, generally of polyester, constituting the support,
an optional layer 2 constituted by the detachment layer (complete or partial) as the case may be. This layer will not exist in the case of the standard label film.
a layer 3 constituting the stamping layer
a layer 5 formed by a metal (aluminum or another metal or alloy) evaporated under vacuum, which gives to the film its color.
an adhesive layer 6 of a nature adapted to the type of product produced. It can be coated, laminated or complexed on the product as the case may be.

Certain operations require the expertise of the producer of holographic films:
the transparent polyester film
the detachment layer (in the case of hot marking or destructible labels)
the stamping layer in which the producer of the hologram will press the suitable microstructures (diffraction network, holograms, . . .)

Other operations take advantage of the expertise of the producer of holograms:
stamping
the deposit of the layer of metal by evaporation under vacuum. Aluminum is the most frequently used metal for technical and financial reasons. Chromium, copper and gold are sometimes required, but need equipment such as an electron gun (material more costly and process longer).

Given the production processes, it is not economically possible to undertake production of very small quantities with this first solution. This process also lacks the flexibility of the range of colors achievable.

The second solution of the state of the art leads to a structure shown in FIG. 2, comprising:
a layer 4 constituted by a layer of translucent colored varnish coated over all the surface of the film. It can in certain cases be combined with the stamping layer (3), in which the hologram producer will press the appropriate microstructures,
a layer 5b is formed by a layer of aluminum deposited by evaporation under vacuum.

The present invention seeks to provide an improved solution for the production of a holographic film having a metallic aspect, permitting the hologram producer, who does not necessarily have skill in the production of films, to control the appearance of the film and to produce all the metallized colors imaginable even in small quantities.

To this end, the invention relates generally to a process for the preparation of an optical security component having a metallized appearance, and comprising a defraction network characterized in that it comprises a step of preparation of a transparent polyester film, a step of depositing a stamping layer in which the hologram producer will press the appropriate microstructures, a stamping step, and a step of depositing under vacuum a thin layer of a dieletric material of high optical index, followed by a step of coating with a layer of translucent colored varnish and a step of depositing under vacuum a layer of aluminum.

Preferably, the layer of dielectric material of high optical index is constituted by zinc sulfide ZnS of a thickness of about 60 nm.

According to a preferred embodiment, the layer of aluminum has a thickness of about 55 nm.

According to a modification, the process comprises a step of superposition on the transparent film of a detachment layer.

According to another modification, the process comprises a supplemental step of partial demetallization of the aluminum layer.

The invention also relates to an optical security component obtained by this process, this component having a metallized appearance, and comprising a diffraction network characterized in that it is constituted by a transparent film 1 of polyester, a stamping layer 3, a layer 7 of high index of optical refraction, a thin layer 4b is of a colored varnish preferably translucent.

According to a modification, it moreover comprises a detachment layer 2.

The invention will be better understood from a reading of the description which follows, relating to the accompanying drawings, corresponding to non-limiting examples of embodiment, in which:

FIG. 1 is a cross-sectional view of a film according to a first solution of the prior art.

FIG. 2 is a cross-sectional view of a film according to a second solution according to the prior art.

FIG. 3 is a cross-sectional view of a film according to the invention.

FIG. 4 is a cross-sectional view of a modified embodiment.

FIG. 5 is a cross-sectional view of another modified embodiment.

FIG. 6 is a view in cross-section of another modification.

The process according to the invention comprises the following steps:
Preparation of a transparent polyester film,
Optional superposition of a detachment layer (in the case of hot marking of destructible labels),
Deposit of a stamping layer in which the hologram producer will press the appropriate microstructures,
Stamping,
Deposition under vacuum of a thin layer of a dielectric material of high optical index (typically ZnS) (about 60 nm),
Coating a layer of translucent colored varnish (typically yellow orange if a final golden appearance is desired),
Deposition under vacuum of an aluminum layer (about 55 nm).

The product thus produced, of which FIG. 3 represents a cross-sectional view, comprises:
a transparent film 1 of polyester,
if desired, a detachment layer 2,
a stamping layer 3,
a layer 7 of high index of optical refraction (typically Zns),
a thin layer 4b is of a colored varnish, preferably translucent.

To obtain a “golden” appearance, the varnish will have a yellow orange color.

To obtain a “Chrome” appearance, the varnish will have a gray-blue color.

To obtain a “Nickel” appearance, the varnish will have a gray-green color.

To obtain a “Copper” appearance, the varnish will have a red-orange color.

To obtain a “Gun Metal” appearance, the varnish will have a brown-black color.

To obtain a flat appearance, the varnish will have a flat silver color.

FIG. 4 is a cross-sectional view of a modified embodiment.

This modification permits producing a holographic film having colored metallized appearances variable from one place to another in perfect registry with the holographic or diffraction image.

In this embodiment, the layer 4ter is a layer of translucent colored varnish imprinted locally in register or not with the hologram.

There will be used for this purpose the same principle as before, with the difference that the translucent colored varnish is no longer coated uniformly over all the surface, but imprinted with a high definition.

The impression will preferably be carried out in registry with the holographic image.

An orange-yellow varnish will permit preferably obtaining a golden effect.

This modification is also well adapted to the production of films of labels as well as for hot marking films or laminates. These components are easily describable, which facilitates their authentication at a glance. The transparent zones permit their use in markets connected with identification.

FIG. 5 is a cross-sectional view of another modified embodiment.

The process comprises a supplemental step of partial demetallization of the aluminum layer. There will thus be obtained a component having at least four different appearances:
transparent appearance (diffracting),
diffracting translucent yellow appearance,
diffracting metallized golden appearance,
diffracting aluminum appearance.

The layer 5ter represents the partially metallized aluminum layer.

The layer 8 is a facultative layer of protective varnish. This layer is necessary in the case in which the layer 4b is does not resist the process permitting obtaining partial metallization.

This improvement is possible also in the case in which the layer of varnish 4b is is not coated over all the surface but is locally printed (layer 4ter FIG. 4).

FIG. 6 is a cross-sectional view of another modification. This modification comprises the addition of a transparent layer carrying a level 2 security of the UV or infrared type.

The layer 9 is a layer of transparent varnish such as a layer of varnish visible under UV, a layer visible under infrared, a thermochromic layer transparent at ambient temperature, a layer comprising a biological tracer (DNA for example) or any other marking varnish whose restitution takes place by means of an apparatus emitting or filtering a specific wavelength. It can be either coated over all the surface, or printed preferably in registry to the holographic image. It can also be combined with the layer 4b is (FIGS. 3, 5 and 6) or 4ter (FIG. 4).

The layer of varnish can be constituted by several layers. There are thus successively printed several layers of varnish of different colors so as to obtain two, three or four different metallized appearances on the same diffracting security element.

1. Process for the preparation of an optical security component having a metallized appearance, and comprising a diffraction network, characterized in that it comprises a step of preparation of a transparent polyester film, a step of deposition of a stamping layer in which the hologram producer will press the appropriate microstructures, a step of stamping and a step of deposition under vacuum of a thin layer of a dielectric material of high optical index, followed by a step of coating or printing at least one layer of colored translucent varnish and a step of deposition under vacuum of an aluminum layer.

2. Process for the preparation of an optical security component having a metallized appearance according to claim 1, characterized in that the layer of a dielectric material of high optical index is constituted by zinc sulfide ZnS of a thickness of about 60 nm.

3. Process for the preparation of an optical security component having a metallized appearance according to claim 1, characterized in that the layer of translucent varnish has a thickness of about 55 nm.

4. Process for the preparation of an optical security component having a metallized appearance according to claim 1, characterized in that it comprises a step of superposition on the transparent film 1 of a detachment layer.

5. Process for the preparation of an optical security component having a metallized appearance according to claim 1, characterized in that it comprises a supplemental step of partial demetallization of the aluminum layer.

6. Process for the preparation of an optical security component having a metallized appearance according to claim 1, characterized in that a plurality of layers of colored varnish are imprinted.

7. Optical security component having a metallized appearance, and comprising a diffraction network characterized in that it is constituted by a transparent polyester film 1, a stamping layer 3, a layer 7 of high optical index of refraction, a thin layer 4b is of a colored varnish, preferably translucent, and a layer of aluminum.

8. Optical security component according to claim 7, characterized in that it comprises moreover a detachment layer 2.

9. Optical security component according to claim 7, characterized in that it comprises moreover a layer 4b is of translucent colored varnish imprinted locally in registry or not with the hologram.

10. Optical security component according to claim 9, characterized in that it comprises moreover a transparent layer which carries a level 2 security of the UV or infrared type.

11. Optical security component according to claim 8, characterized in that it comprises moreover a detachment layer 2.
